(19) United States
(12) Patent Application Publication
(10) Pub. No.: US 2023/0107602 A1
(43) Pub. Date: Apr. 6, 2023

(54) METHOD AND SYSTEM FOR LIFE AND LONG-TERM CARE INSURANCE

(71) Applicants: Nathaniel J. Krasnoff, Los Angeles, CA (US); Loida R. Abraham, Sudbury, MA (US)

(72) Inventors: Nathaniel J. Krasnoff, Los Angeles, CA (US); Loida R. Abraham, Sudbury, MA (US)

(21) Appl. No.: 17/957,177

(22) Filed: Sep. 30, 2022

Related U.S. Application Data
(60) Provisional application No. 63/251,363, filed on Oct. 1, 2021.

(51) Int. Cl. G06Q 40/08

(52) U.S. Cl. CPC G06Q 40/08

(57) ABSTRACT

A computer-implemented system and method are disclosed in which a processing unit receives information regarding a plurality of potential customers, each of whom is associated with a potential three-phase insurance policy. The processing unit performs machine learning to perform intelligent underwriting of the three-phase insurance policy for a plurality of qualified customers. After determining that the qualified customers have purchased the three-phase insurance policy, the processing unit simultaneously and automatically updates the three-phase insurance policies for the plurality of qualified customers upon approaching a threshold from one phase of the three-phase insurance policy to a subsequent phase of the three-phase insurance policy. The processing unit then automatically generates a notification to the plurality of qualified customers whose insurance policies are updated.

### CROSS REFERENCE TO RELATED APPLICATION

This application claims priority to and the benefit of U.S. Provisional Application Ser. No. 63/251,363, filed Oct. 1, 2021, the disclosure of which is incorporated herein by reference in its entirety.

### TECHNICAL FIELD

The present disclosure relates to insurance policy management systems and methods that manage and configure data and status of insurance policies.

### BACKGROUND

Insurance offers people financial protection during various stages in their lives as their needs change. For example, financial needs may include income and security for a person's family in the event that the person dies, as well as resources to pay for the long-term care for the person as he or she ages. However, it is neither possible nor reasonable to expect the person to be fully aware of and prepare for all possible scenarios which may arise during the later phases of his or her life. Statistics show that: 6 months is the amount of time that almost half of American households would experience financial hardship after the loss of a wage earner, 70% is the likelihood that someone age 65 or older will need long-term care at some point in his or her life, and $4,000 to $10,000 per month is the average cost of care range. Therefore, there is a need for a more flexible insurance policy to accommodate such different scenarios as well as the means of managing and modifying the same.

### SUMMARY OF THE DISCLOSURE

According to the present disclosure, a computer-implemented system and method are disclosed in which a processing unit receives information regarding a plurality of potential customers, each of whom is associated with a potential three-phase insurance policy. The processing unit performs machine learning to perform intelligent underwriting of the three-phase insurance policy for a plurality of qualified customers. After determining that the qualified customers have purchased the three-phase insurance policy, the processing unit simultaneously and automatically updates the three-phase insurance policies for the plurality of qualified customers upon approaching a threshold from one phase of the three-phase insurance policy to a subsequent phase of the three-phase insurance policy. The processing unit then automatically generates a notification to the plurality of qualified customers whose insurance policies are updated.

Additional features and advantages of the present disclosure will become apparent to those skilled in the art upon consideration of the following detailed description of the illustrative embodiment exemplifying the best mode of carrying out the disclosure as presently perceived.

### BRIEF DESCRIPTION OF THE DRAWINGS

The detailed description of drawings particularly refers to the accompanying figures in which:

FIG. 1 is a schematic diagram of a computing system which performs the processes as disclosed herein, according to embodiments disclosed herein.

FIG. 2 is a schematic diagram of a broker-side user interface according to embodiments disclosed herein.

FIG. 3 is a schematic diagram of a customer-side user interface according to embodiments disclosed herein.

FIG. 4 is a flowchart of a process performed by the computing system according to embodiments disclosed herein.

FIG. 5A is a flowchart of a three-phase insurance policy according to embodiments disclosed herein.

FIG. 5B is a graph illustratively showing a time vs available cash benefits of the three-phase insurance policy of FIG. 5A according to embodiments disclosed herein.

### DETAILED DESCRIPTION

The embodiments of the disclosure described herein are not intended to be exhaustive or to limit the disclosure to the precise forms disclosed. Rather, the embodiments selected for description have been chosen to enable one skilled in the art to practice the disclosure.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example.

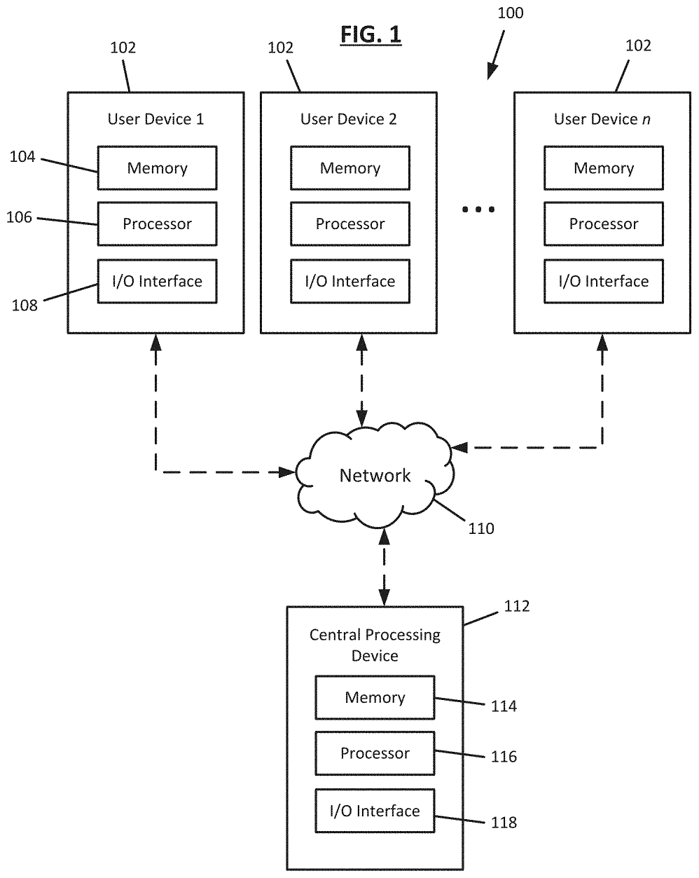

FIG. 1 illustrates an example of a computing system 100 that may be implemented to perform the process or method as further discussed herein. The system 100 includes a network 110 which operatively connects a central processing device 112 with a plurality of user devices 102 (labeled “User Device 1,” “User Device 2,” “User Device n,” etc.). The user devices 102 each includes a memory unit 104, a processing unit or processor 106, and an I/O interface 108 for communicating with other devices via the network 110. The central processing device 112 may include a memory unit 114, a processing unit or processor 116, and an I/O interface 118 for communicating with other devices via the network 110. Examples of the device 102 and/or 112 may include, but are not limited to, one or more workstations, servers, cloud computing platforms, laptops, desktops, tablet computers, hand-held devices, general-purpose units, state machines, APUs, CPUs, GPUs, and the like, all of which are contemplated within the scope of the device. The memory unit 104, 114 may be or include RAM, ROM, or any other suitable memory and/or medium. In some examples, the memory unit 104, 114 includes computer-executable instructions that when executed cause a processor (e.g., processor 106, 116) to cause the device 102 and/or 112 to implement aspects of embodiments as discussed herein and/or to perform aspects of embodiments of methods and procedures discussed herein. As discussed herein, the devices 102 may be used by an insurance broker, a potential customer for an insurance policy, and/or a current customer who has purchased the insurance policy, as suitable.

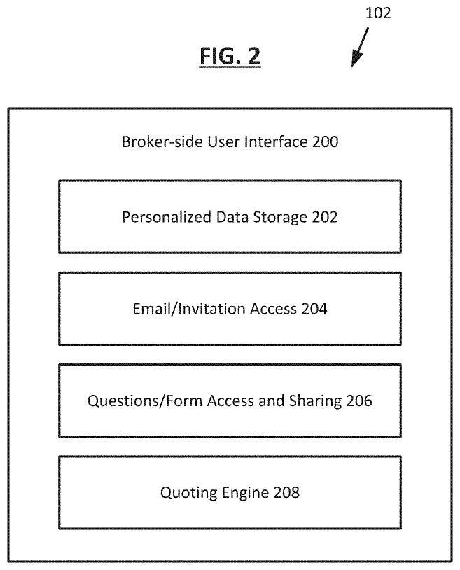

FIG. 2 illustrates an example of a broker-side user interface 200 which may be shown on any of the suitable devices 102. For example, the interface 200 may show personalized data storage 202 which includes informative data that may be beneficial for the broker in proposing potential customers with prospective insurance policies. A non-exhaustive list of examples of such data is provided herein. For example, the data may include digital documents of a producer selling guide (e.g., with language and ideas on how to sell the product), prospecting programs for potential customers, and/or worksite association marketing procedures. For example, the data may include an underwriting (UW) guide such as prescreening questions for potential customers, lists of diseases in alphabetical order or risk status, and/or lists of medications including those which may be uninsurable or need more information. For example, the data may include product information regarding the different insurance policies that are offered, as well as a consumer guide, frequently asked questions (FAQs), and documents explaining specific product features. For example, the data may include case reports, sales progress, and a list of incentives for the broker, for example new business status reports which may be shown in different ways, commissions, and sales contests for the brokers. For example, the data may include announcements such as monthly news and producer communications. Any other types of data may be included as well.

The interface 200 may also include email access or invitation access 204 which may include a user interface for sending and receiving communications including but not limited to emails. Invitations may include messages such as SMS or chat messages which invite certain potential customers to meet with the broker for a discussion regarding potential insurance products. The invitations may be sent via emails or SMS or any other suitable means including but not limited to telephone calls. Announcements may be received or sent via the email access 204 interface. The interface 200 may also include access 206 to questions or forms as well as an interface for sharing the same with the potential customers and/or the system. The questions may be chosen from the prescreening questions, or an entire form that is stored in the system may be sent to the potential customers for them to complete. The interface 200 may also include a quoting engine 208 which may assist the broker in preparing the quotes for insurance products based on customer response to questionnaires or forms as completed. In some examples, the quoting engine 208 may generate sales illustration and comparison charts for the broker's and/or customer's reference. The quoting engine 208 may automatically and instantaneously generate the quotes or illustrations/comparisons using any suitable means, process, or algorithm as known in the art.

Beneficially, the interface 200 encourages producers to market the insurance products by making it easier and faster to sell products online, using for example sales tools as described herein, as well as by providing information on any one or more of the following: case status, commissions, sales incentives, and/or rank amongst other producers (e.g., top ten list). The interface 200 may encourage a new business process of allowing the broker to explain the needs and sell product concepts to potential customers, such that potential customers may want to hear more and agree to fill out a questionnaire online, which may include HIPPA authorization forms, prescreening questions, and/or medication and non-medication questions, to apply for certain insurance products, with the assistance of the underwriting engine (e.g., the broker interface 200). Subsequently, the interface 200 may determine the rating of the potential customers and inform the broker accordingly. For example, if the customer's application is declined, the broker may be offered alternative options to propose to the customer, and if the customer is approved, the broker may help the potential customers determine the best plans or insurance policies to apply, based on the customers' target benefit/premium data using sales illustration, for example. The potential customers may fill out the rest of the application forms and submit them with assistance from the interface 200. Then, a third-party administrator (TPA) may receive the application information, review it for completion and accuracy, and if everything is correctly filled out, the TPA may apply the payment option and then email a contract for the policy to the applicants (potential customers) for review, approval, and signature, with a copy of the email to the broker.

In some examples, the underwriting may be performed using machine learning by the appropriate device 102 or 112. For example, machine learning may be implemented by the device to “learn” based on the data provided to the device from a database, for example a company's server, regarding who has been approved for which insurance policies in the past, such that the device can make a learned determination on how to verify the information submitted by the applicant in the questionnaires, in order to issue final approval for the insurance policy for the applicant. The data may be retrieved from different databases or servers. The machine learning process may be implemented using any suitable training methods using the aforementioned data as training data, as known in the art. As such, the machine learning may facilitate intelligent underwriting of insurance applications so as to provide improvement in the technological field of online insurance underwriting and application, which beneficially increases the flexibility, convenience, and accuracy of the process when compared to the traditional underwriting process, which take longer and require the potential customers to undergo more steps in the process such as requiring a visit to the physician to be able to complete the application. Advantageously, the machine-learning-assisted intelligent underwriting of insurance applications may be performed as a fluid-free Internet-based (or Web-based) underwriting process which that eliminates the need for fluid testing during the underwriting process, thereby allowing for agents in financial institutions to quickly and easily offer insurance coverage and issue policies for the customers within a short period of time, for example within minutes. The fluid-free Internet-based intelligent underwriting process is unique to the three-phase insurance policy as further explained herein. Therefore, the machine-learning-assisted intelligent underwriting is completed online within minutes, with no labs, examinations, interviews (e.g., for certain applicants such as the actively-at-work applicants up to the age of 65 years or any other suitable age range), and decisions can be received by the applicants online within minutes as well. The range of “within minutes” as described herein may be less than 10 minutes, less than 5 minutes, less than 1 minute, or any other value or range therebetween, as appropriate. It should be understood that the machine learning process allows for the devices 102, 112 to perform any suitable number of data transactions and modifications in the system automatically, simultaneously, and/or in real-time as suitable, including but not limited to at least 100 data transactions, at least 1000 data transactions, at least 10,000 data transactions, or any other suitable value or range therebetween, per second or per minute, as allowed by the device's data processing and data communication capabilities with the other devices in the system via the network 110 as disclosed herein. As such, in some examples, the intelligent underwriting may be performed in just as many numbers as the number of possible data transactions at the aforementioned rate or speed.

Additionally, the broker interface 200 may include, in the personalized data storage 202, personal login information which may be stored in a section of the memory 104 of the device 102 that is specific to the broker. For example, the system may perform license checks and continuing education (CE) checks for all states in which the broker is qualified to sell products, allow the broker to store all information pertaining to the prospective customers (e.g., name, contact information, status of application, etc.), as well as obtain information for the broker on all the business that he or she performs with a company using the system, including but not limited to any pending applications, new issues, and commissions associated therewith and to be enforced. The broker-enabled access 204 and 206 makes selling insurance products easier because the broker has options to send a system-generated email to prospective customers to confirm initial appointment times and locations, and to allow the prospective customers to learn about the product on their own time by providing them with a link to the appropriate learning resources available in the system. In some examples, if the email/invitations are sent to the prospective customers, the action automatically establishes a user ID and a password that are specific to each prospective customer, so as to allow them access to the “learning” section of the system temporarily or permanently. In some examples, after completing the “learning” section, the prospective customers may be encouraged to fill out the first part of the application forms, e.g., the prescreening questions, medication and non-medication questions, and electronically sign HIPPA forms. This allows the underwriting engine to determine the underwriting status of the prospective customers. In some examples, the system may track the status of the prospective customers at each step of the process, such as logging each time the prospective customers sign in to the system and the time spent on the “learning” and application sections, and such information may be provided to the broker via electronic communications or notifications. In response, the broker may arrange a meeting (using the invitation access 204 interface, for example) with the prospective customers to browse the websites together to go over the process. If the prospective customers are approved for the insurance product and agree to purchase the same, further questions may be generated by the system and/or completed by the customers, after which the prospective customers may electronically sign the application. The signed application is returned to the broker to also electronically sign, and the commission may be split if needed. Lastly, the broker is then able to submit the application directly for straight-through processing.

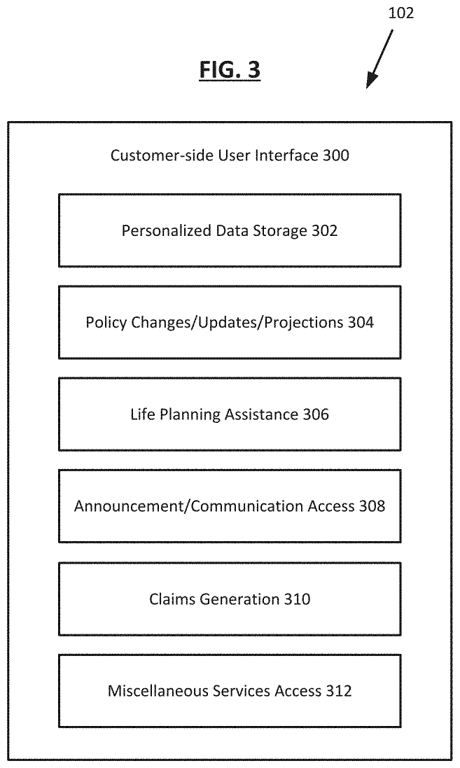

FIG. 3 illustrates an example of a customer-side user interface 300 which may be shown on any of the suitable devices 102. For example, the interface 300 may show personalized data storage 302 which includes informative data that may be beneficial for the customers (or potential/prospective customers) with regards to prospective insurance policies or insurance policies for which the customers are already signed up. A non-exhaustive list of examples of such data is provided herein. For example, the data may include digital documents of policy contracts and all associated forms, such as application, outline of coverage, etc. The documents may include sales illustrations, all relevant contact information such as those of the insurance company and the broker, as well as call center information (or online chat window) for use by the customers, as appropriate. The interface 300 may include an interface for policy changes, updates, and/or projections 304, such as the status of the benefits that the customers are entitled to, such as for the life insurance, long-term care (LTC) benefits, withdrawals, loans, and net benefits, as well as the premiums paid to date including any other suitable supplementary information such as wellness credits, and investment performance if the customers are also participating in the investment program, as well as updated projections for the investment or benefits, as further explained herein. The interface 300 also includes an interface for life planning assistance 306, which assists with planning for a three-phase insurance policy as further discussed herein, and tips on healthy aging as well as estate planning, among others as suitable. The interface 300 also includes an interface for announcement or communication access 308, such as monthly news such as new product announcements and/or new provider joining, as well as customer communications with other personnel such as the broker.

The interface 300 also includes improved functionality in the form of an interface for policy changes (which may be part of the policy changes, updates, and/or projections interface 304) such that personal information of the customers are stored, and life insurance benefits can be accessed, including face amount, withdrawals and loans, and/or indexed universal life (IUL) insurance product options. The interface 300 also includes an interface for claims generation 310 which explains how to process a withdrawal, how to process a loan, and/or how to process a death claim, for example. The interface for claims generation 310 can also explain how to process a LTC claim, including tax-qualified benefit triggers, care plans, access to LTC providers, etc. An interface for miscellaneous services access 312 may also be provided for access to other services, including help for a family member needing LTC services, future planning, and an end-of-life service package, for example. In some examples, such miscellaneous services access 312 may include access to a care advisory service, which may be an online resource center included at no cost in the policy. For example, such service may provide a care concierge to talk with the customers when questions arise, a navigator tool to help the customers find home care or facility care options for them or their parents, a cost-of-care map to enable the customers to research LTC costs in different regions and towns, quality ratings of various care providers, and/or discounts to a range of providers throughout the country, as suitable.

In some examples, the documents include electronic files (such as PDF documents) of policy contracts, applications, copies of sales illustrations, outlines for coverage, etc. The policy update may reflect life insurance benefits such as death benefits, cash values, loans, withdrawals, etc. The policy update may reflect LTC coverage such as maximum life amount coverage, net of loans, monthly benefits, elimination period, etc. The policy update may also reflect the premiums paid to date. Informative data may also include information about the crediting rate development as well as other types of investment performance, which may be represented visually in a graph, as well as a table showing the actual and projected benefits, as suitable.

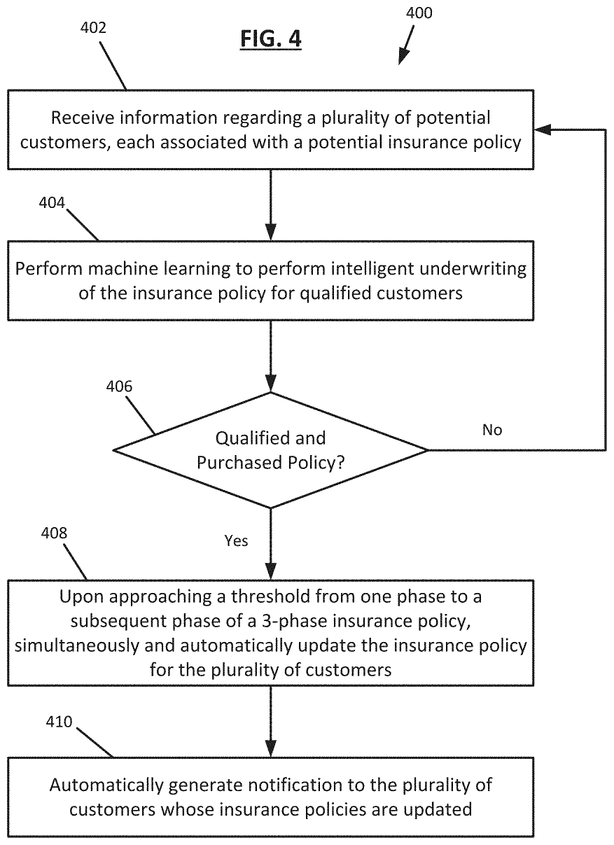

Informative life planning data may include explanations of the life stages, which may include three phases. In FIG. 4, a method 400 (or a process or algorithm) is implemented by the device 112 such that the device 112 receives information regarding a plurality of potential customers, each associated with a potential insurance policy, in step 402. The insurance policy may be the three-phase policy as explained further herein. In step 404, the device 112 performs machine learning to perform intelligent underwriting of the three-phase insurance policy for the qualified potential customers. The machine learning may be performed by using any suitable training data to allow the device 112 to determine the potential customers to be qualified to purchase the policy.

A processor or a processing element (e.g., central processing device 112) may be trained using supervised/unsupervised machine learning or reinforcement learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs of data in order to make valid and reliable predictions for novel inputs.

Additionally or alternatively, the machine learning programs may be trained by inputting sample data sets or certain data into the programs as well as observing the interactions between operators and the system. The machine learning programs may utilize deep learning algorithms primarily focused on pattern recognition, and may be trained after processing multiple examples. The machine learning programs may include Bayesian program learning (BPL), random forests, support-vector machines, naïve bayesian classifiers, Q-learning, generative adversarial networks, simulated annealing, principle/independent component analysis, policy gradients, anomaly detection, voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct or a preferred output. In unsupervised machine learning, the processing element may be required to find its own structure in unlabeled example inputs. In reinforcement learning, the processing element may find an optimal action for a state based upon the rewards provided for a particular environment. The machine learning programs may be trained with any suitable training data to determine how to perform the intelligent underwriting of the three-phase insurance policy for the potential customers who are qualified for the insurance policy.

After training, machine learning programs (or information generated by such machine learning programs) may be used to evaluate additional data. Such data may be related to other potentially qualified customers, or other similar data to be analyzed or processed. Such trained machine learning programs may, thus, be used to perform part or all of the analytical functions of the methods described elsewhere herein.

In step 406, the device 112 determines whether the customer is qualified and whether the customer has purchased the policy. If the customer is not qualified or has not purchased the policy, the process 400 returns to gather additional information as in step 402. Otherwise, in step 408, upon approaching a threshold from one phase to a subsequent phase of a three-phase insurance policy (that is, age A and age B as further explained herein), the device 112 may simultaneously and automatically update the insurance policies for the plurality of customers. The number of customers whose insurance policies are updated as such may be at least 100 customers, at least 1000 customers, at least 10,000 customers, or any other suitable value or range therebetween. Then, in step 410, the device 112 automatically generates notifications to the customers whose insurance policies are updated in step 408. The notifications may be displayed visually on the display of the customers' devices 102 or may be supplied audibly as a voice message or voicemail via the customers' devices 102, as suitable.

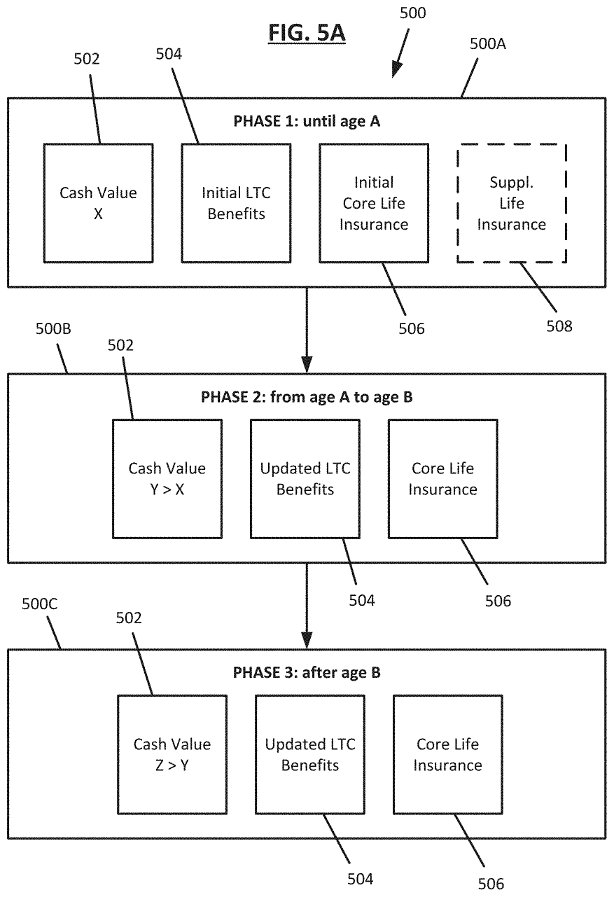

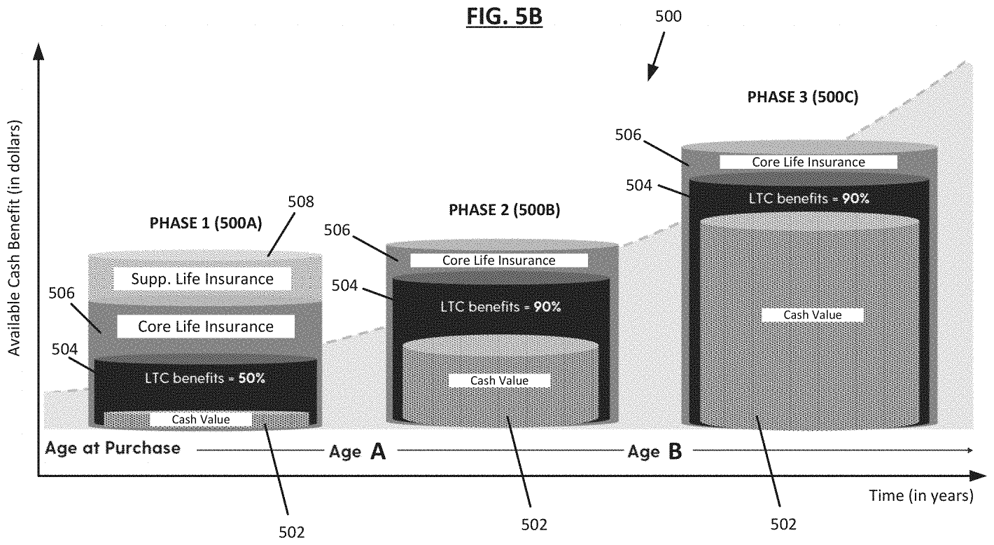

Referring to FIGS. 5A and 5B, for example, a three-phase insurance policy 500 may include a first phase (Phase 1) 500A which remains in effect until a certain age (A) of the policyholder which may be up to the age of in the 60s or 70s, such as 65 years, for example, although other suitable ages may be implemented. Following the first phase 500A is a second phase 500B which spans from age A to an older age (B) of the policyholder which may be up to the age of in the 70s or 80s, such as 80 or 85 years, for example. Each phase has a different cash value 502, LTC benefit 504, and core life insurance 506. The first phase 500A may also include a supplementary life insurance component 508 if the customers so choose. Cash value 502 is a supplemental savings feature of the policy 500 which can earn tax-free interest and increase the value of the insurance benefits over time. A portion of each premium payment is added to the cash value and the balance is credited with interest based on the crediting option that is chosen. Interest crediting options include S&P 500 index and fixed interest. In the S&P 500 index, interest is credited up to an annual maximum (“cap”) rate based on the performance of the S&P 500 index and has a guaranteed 0% floor, which means that customers benefit from returns when the market is performing well and are protected from losses during market downturns. It provides the potential for higher interest crediting than the fixed option and is a good choice for younger people who are interested in maximizing cash value growth. Fixed interest provides a more conservative option for stable growth, with a guaranteed interest crediting rate of 2%. It is a good choice for people later in life who are more interested in stability than growth and protecting what they've earned. Cash value savings can be accessed at any time through tax-free loans, without penalty. These funds can be accessed for any purpose, such as an emergency, as extra retirement income or for travel, etc.

The first phase 500A, which may cover a range of from the 30s to the 60s, for example, may include plans for a growing family in which the customers' career is taking off and family is most dependent on the income earner, who may be the customers, including but not limited to college planning for their children. In this phase, the customer may be healthy but may want to prepare for the future, such that the customers' priorities may include protecting their families in case of their unexpected death, making sure their families' well-being is protected if they someday need LTC, and/or accumulating additional savings for later in life. Specifically, in some examples, the policy offers life insurance that provides for the customers' families in case of the unexpected death of the customers, and LTC insurance coverage or an initial LTC benefit 504 that is an additional sum equal to 50% of the face value of the life insurance or initial core life insurance 506, should the customers need it before reaching the age of 65 years. If the funds are to be used for LTC in this phase, the customers would still have the full amount of life insurance available. The power of an extended universal life (UL) insurance policy, which allows the premiums to be invested and to grow in line with the S&P 500 index, is that it results in a cash value X 502 that builds over time. Growth of benefits and cash value relies on the policies being funded as planned, and the index crediting rate being sufficient to cover annual charges. Interest crediting fluctuations may result in reduced policy values and the need for additional premiums in the customers' policies.

In second phase 500B, which may cover a range of ages from the 60s to the 70s or from the 60s to the 80s, for example, may include plans for empty nesters such as those who have paid off for children's college tuition or their own college tuition and/or mortgage for their homes. There may be room for more travel and the family is less dependent on the income earner, but there may be more concern over health issues. In this phase, the children may have become young adults and have left home for college or their first careers. The customers and their spouses may be planning for travels and having more time to themselves, such that their priorities may shift because, with the mortgage mostly or entirely paid, their families' security is less dependent on their income, but life insurance would still be important when the children are in college and/or young adults. In some examples, the customers may be seeing more people like their parents needing LTC, and they may prefer to have the coverage in place. In some examples, the customers may be saving more aggressively for their future goals by taking advantage of the market's historical growth. Specifically, in some examples, the policy is adjusted starting at a certain age A, which may be 65 years, such that the customers' life insurance benefits 506 remains the same to cover their families in case of an unexpected death, but the LTC coverage benefit 504 increases to 90% of the face value of their life insurance, which means that it is paid from that pool of money. Should the customers use the funds for LTC in this phase, they would still have a 10% death benefit available. The IUL policy continues to allow the customers' premiums to be invested and to grow in line with the S&P 500 index, resulting in cash value Y 502 that builds over time and is greater than the cash value X in the first phase 500A.

In third phase 500C, which may cover a range of ages from the 70s to any age thereafter or the 80s to any age thereafter, for example, may include plans for retirees, who may have real concerns about LTC and other health-related needs as well as concerns over other financial issues of aging. Such phases may be incorporated into the healthy aging tip and informative life planning process as shown or accessed via the appropriate interface as previously disclosed, such that the customers may stay financially fit throughout the different years of coverage by the insurance plan. In this phase, the customers may be spending more time with their children and grandchildren and their priorities my shift to staying healthy for as long as possible but knowing that they still have LTC coverage to cover the costs for when they do need care for assurance. In some examples, the customers may leave something to their partners or children when they die, but the amount that is required for their families might not be as much as when the families were young and their expenses higher. As such, having the flexibility to access additional funds would be preferred. Specifically, in some examples, the policy offers a life insurance face value that has grown to a value much greater than the original face amount, and the cash value Z 502 is growing and reaches the face value in the later years of third phase 500C, for example when the customers reach the age of 100 years, which is greater than cash value Y in the second phase 500B. Additionally, in second phase 500B or third phase 500C, cash value can also grow over time as a result of the policy being linked to the S&P 500 index and is protected from losses with a 0% guaranteed floor. Thus, customers can access the available cash value for any purpose such as supplemental income, travel, home modifications, etc.

As an illustrative example, a customer may be a 40-year-old man with a partner and two children at the time of purchasing the insurance policy. He determines that he needs $500,000 in life insurance early on to cover his mortgage and other costs in case of his untimely death. He also wants to lock in LTC insurance. In this example, in first phase 500A, the life insurance coverage of $500,000 and LTC insurance coverage of $250,000 are initially applied. In second phase 500B which beings when the customer reaches the age of 65 years, the life insurance coverage remains the same but includes the LTC pool of money which is 90% of the life insurance face value, i.e. $450,000, and the remaining death benefit amounts to $50,000, while the IUL cash value builds. In third phase 500C which begins when the customer reaches the age of 85 years, when the customer reaches 90 years of age, the cash value reaches $1.3 million, and the face value of the policy reaches $1.4 million. When the customer reaches 100 years of age, the face value increases to $2.2 million, while the life insurance face value equals the cash value throughout the entirety of the phase as the LTC pool of money equals 90% of the face value at any particular time, while the remaining death benefit is 10% of the life insurance face value. To summarize, before the age of 65 years, the customer's LTC coverage pool is equal to 50% of the face value of his life insurance, and after the age of 65 years, his LTC coverage pool is equal to 90% of the face value of his policy, which has likely grown over the years due to the indexed fund investments. When he needs LTC, once the 90-day elimination period (like a deductible period) is met, he can begin to access his benefits. The LTC benefits will be paid monthly on an indemnity (cash) basis, over a 3-year period. So, based on this example, if the customer needs LTC before the age of 65, the LTC benefits will be $250,000 divided into 36 months, which equals $6944 per month for 3 years. If the customer needs LTC after the age of 65, at the age of 90, the face value equals $1.4 million, so the LTC coverage pool is 90% of it, which equals $1.26 million, and his LTC benefit will be $1.26 million divided into 36 months, which equals $35,000 per month for 3 years.

The aforementioned policy offers benefits not observed in currently known insurance policies. For example, the traditional life insurance policies credit customers' policy based on interest rates, which are expected to remain at unprecedented lows for an indefinite period. Linking customers' policy to an Index will allow the customers to take advantage of equity growth in the market. Also, government funds for LTC are limited to none, and every year the costs of LTC increase significantly. With COVID-19 and other unknown viruses becoming more pervasive, customers may not want to wait to get the insurance they need, so they may prefer to take advantage of their health to buy insurance at competitive rates when they are young.

The customer-side user interface 300 may therefore offer improved functionality in that the interface allows for making changes to the customers' policies such as change of address, beneficiary, etc., as well as allowing for making policy loans or withdrawals and/or providing information on impact to future benefits. The interface may also allow for filing a death claim or LTC claim, as well as allowing the customers for connecting to LTC provider for themselves or for their family members. The interface may also allow for connecting the customers to resources on end-of-life planning, if applicable.

Regarding LTC, the device 102, 112 and/or the system 100 as a whole may be implemented to recognize the varying needs and requirements of the customers during the different phases as described above. For example, the system may recommend that the clients buy life and LTC insurance when they are relatively younger and healthier (such as in first phase 500A) before future illnesses may impede their ability to qualify for such coverage, and because the younger they are when the purchase the policy, the more affordable the premiums would be. The system also recognizes that there is 70% likelihood that someone age 65 or older may need LTC at some point in his or her life. Specifically, in the year 2020, the national monthly median costs for LTC ranged from $4400 to $8800, and statistically, women need the care for a longer period of time (3.7 years) than men (2.2 years). Furthermore, one-third of today's 65-year-old population may never need LTC support, but 20% thereof would need it for longer than 5 years. Such variables are also taken into account when the system recommends or modifies the plans of each customer according to their current status, as appropriate. Because governmental programs generally do not cover LTC unless one is impoverished, and because health insurance does not cover LTC expenses, alternatives are few, and without the resources or coverage to pay for the care, the customers' fallback is often burdening their family members with their care. As such, there is an observed benefit in the customer-based intelligent recommendation process which may be applied by the device 102, 112 or any other suitable computing processing unit within the system 100 as shown.

The three-phase insurance product 500 offers initially a life insurance policy that protects customers' families if they die young, i.e., before a predetermined age threshold (life insurance), and subsequently locks in coverage early on when the customers are young and healthy such that they can cover the high expenses of LTC should they ever need it (LTC insurance), after which the cash value feature provides the flexibility to have an additional source of income or funds to use on occasions if needed (additional savings). Therefore, the three-phase insurance product 500 provides security for the customers' families with life insurance, a strong financial plan for the customers' future with LTC insurance, and a peace of mind by providing access to additional funds, such that the customers no longer need to worry about the alternative or to take chances.

Although the examples and embodiments have been described in detail with reference to certain preferred embodiments, variations and modifications exist within the spirit and scope of the disclosure as described and defined in the following claims.

What is claimed is:

1. A computer-implemented method comprising:
receiving, by a processing unit, information regarding a plurality of potential customers, each of whom is associated with a potential three-phase insurance policy;
performing, by the processing unit, machine learning to perform intelligent underwriting of the three-phase insurance policy for a plurality of qualified customers;
in response to determining, by the processing unit, that the qualified customers have purchased the three-phase insurance policy, upon approaching a threshold from one phase of the three-phase insurance policy to a subsequent phase of the three-phase insurance policy, simultaneously and automatically updating, by the processing unit, the three-phase insurance policies for the plurality of qualified customers; and
automatically generating, by the processing unit, a notification to the plurality of qualified customers whose insurance policies are updated.
